(19) United States
(12) Patent Application Publication
(10) Pub. No.: US 2007/0098429 A1
(43) Pub. Date: May 3, 2007

(54) Image forming device

(76) Inventors: Syuji Hayashi, Osaka (JP); Yoshiko Harada, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,890

(22) Filed: Oct. 27, 2005

(51) Int. Cl. G03G 15/00

(52) U.S. Cl. 399/82

(57) ABSTRACT

The image forming device is capable of stapling up to a predetermined maximum number of sheets, and includes a control unit, an image forming unit, and a stapling unit. The control unit is capable of generating output data for image information for which the number of sheets exceeds the maximum number by carrying out image processing including N in 1 reduction processing (where N is a natural number equal to or greater than 1). The image forming unit outputs the output data obtained from the control unit onto sheets. The staple unit staples the sheets onto which the output data has been output.

### FIELD OF THE INVENTION

The present invention relates to an image forming device, and more particularly to an image forming device capable of stapling up to a predetermined number of sheets.

### BACKGROUND INFORMATION

Copiers and other image forming devices provided with the capability of binding a plurality of sheets by stabling are known, but there is a maximum number of sheets that can be bound by stapling.

Therefore, when copying documents where the number of sheets exceeds the maximum number, technology has already been proposed to reduce the number of sheets output to less than the maximum number by subjecting the image information obtained by scanning the document to an N in 1 reduction operation (where N is a natural number equal to or greater than 2) to reduce it.

However, according to the above conventional art the image information on all pages is reduced uniformly by the N in 1 reduction process. Therefore, if a page contains photographs or graphs for example, the printed item may become difficult to read. In this case the sheets will have been wastefully consumed.

In particular, when the number of sheets in the document is large, the value of N becomes large, the reduction ratio increases, and the problems become more pronounced.

An object of the present invention is to provide output that is easy to read for image information containing many types of characteristics when outputting image information that is to be stapled and which exceeds the maximum number of sheets.

### SUMMARY OF THE INVENTION

The image forming device according to claim 1 includes an image processing unit, an output unit, and a stapling unit, and is capable of stapling sheets up to a predetermined maximum number. The image processing unit is capable of generating output data by carrying out an N in 1 reduction operation (where N is a natural number equal to or greater than 2) in accordance with the image characteristics of each page, when the image information exceeds the maximum number. The output unit outputs the output data obtained from the image processing unit onto the transfer medium.

In this device, image processing is carried out according to the characteristics of the image information of each page when the image information exceeds the maximum number of sheets for stapling. For example, text information may be subjected to a 4 in 1 reduction, photographic information left the same size, and graph information subjected to a 2 in 1 reduction. Therefore image information with many characteristics can be output so that it can be easily read.

The present invention is not limited to image information that is read from an original, but can also include print data or facsimile information. Also, the characteristics of each page of image information refers to the print form of the original, such as text, photographs, graphs, or tables.

The image forming device according to claim 2 is a device according to claim 1, further including a conditions input unit in which the image processing conditions for the characteristics of the image information of each page can be input. Also, the image processing unit is capable of processing images in accordance with the image processing conditions input at the conditions input unit.

In this device specifically a user can input a desired value of N, to obtain output in accordance with a user's preferences for ease of reading.

The image forming device according to claim 3 is a device according to claim 2, in which it is possible to command the output unit to output the output data when the image processing conditions have been input and the required number of sheets is equal to or less than the maximum number.

In this device, while a user is selecting the desired N in 1 process according to the characteristics of the image information, it is possible to instruct printing only when the number of sheets output is less than or equal to the maximum number. Therefore printing more sheets than can be stapled is avoided.

The required number of sheets refers to the number of sheets of the transfer medium required to output the output data.

The image forming device according to claim 4 is a device according to claim 1, further including a conditions setting unit and a memory unit. Using the conditions setting unit it is possible to set the image processing conditions in advance according to the characteristics of each page of image information. The memory unit is capable of storing the image processing conditions set in the conditions setting unit. Also, the image processing unit is capable of processing images in accordance with the image processing conditions stored in the memory unit.

In this device, if a user selects in advance their desired N in 1 processes, etc., subsequently the number of sheets will automatically be reduced in accordance with the content of the settings, so when printing it is not necessary for the user to carry out the setting operation.

The image forming device according to claim 5 is a device according to claim 4, further including instruction means for instructing image processing in accordance with image processing conditions stored in the memory unit. Also, the image processing unit is capable of processing images in accordance with the image processing conditions stored in the memory unit when there is an instruction from instruction means.

In this device, even when automatic reduction in the number of sheets is carried out, the device waits for the instruction from the user, so that printing unknown to the user is avoided, and the user is provided with an opportunity for confirmation.

Instruction means could be, for example, a specific button on the display of a touch panel.

According to the present invention, image processing is carried out according to the characteristics of the image information of each page. For example, text information can be subjected to 4 in 1 reduction process, photographic information left the same size, and graph information subjected to a 2 in 1 reduction process. Therefore the output can be easily read even when the original includes image information with many different characteristics.

### BRIEF DESCRIPTION OF THE DRAWINGS

FIG. 1 is a front elevation of an image forming device adopting a first embodiment of the present invention;

FIG. 2 is a block diagram showing the configuration of the above device;

FIG. 3 is a plan view of an operation screen displayed on the display unit of the above device;

FIG. 4 is a plan view of an operation screen displayed on the display unit of the above device;

FIG. 5 is a plan view of an operation screen displayed on the display unit of the above device;

FIG. 6 is a plan view of an operation screen displayed on the display unit of the above device;

FIG. 7 is a plan view of an operation screen displayed on the display unit of the above device; and

FIG. 8 is a flowchart explaining the operation of the above device.

### DETAILED DESCRIPTION OF THE PREFERRED EMBODIMENTS

[Configuration of the Image Forming Device]

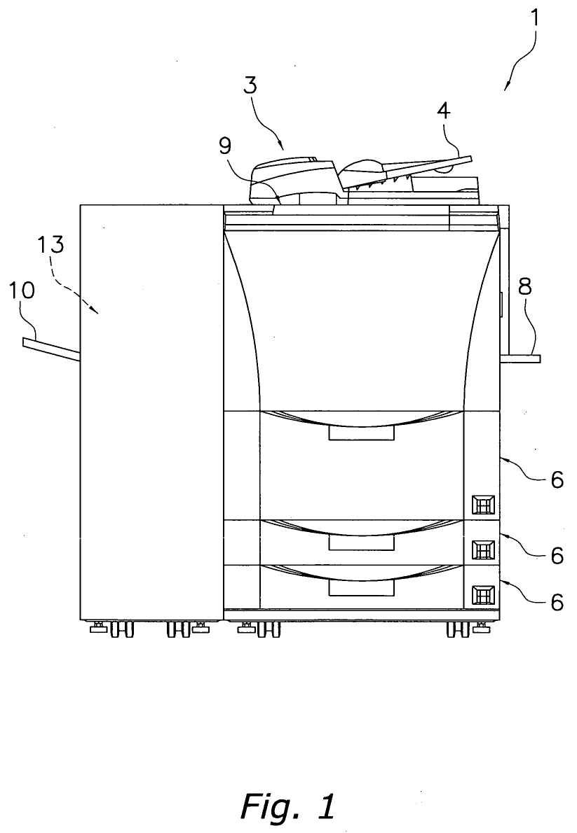

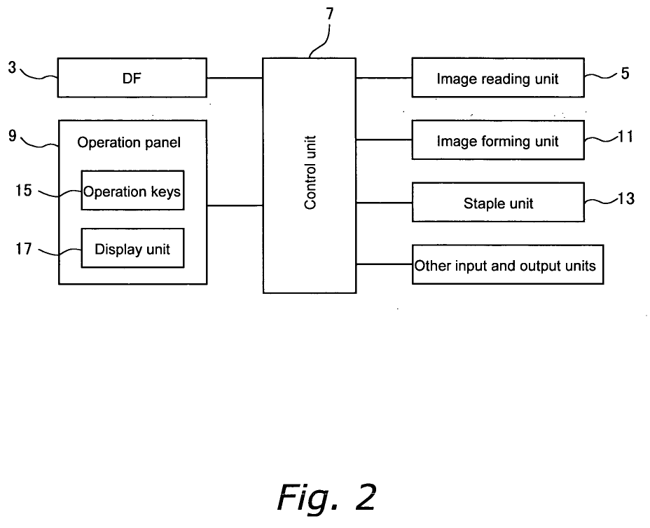

FIG. 1 and FIG. 2 show an image forming device 1 that adopts a first embodiment of the present invention.

The image forming device 1 is an all-in-one machine that includes the functions of copier, printer, facsimile device, and scanner. The image forming device 1 includes a document feeder unit (hereafter referred to as the DF) 3, an image reading unit 5, a control unit (image processing unit) 7, an operation panel 9, an image forming unit (output unit) 11, a staple unit 13, and other input and output units.

The DF 3 includes an original document loading tray 4 for loading original documents. Original documents set in the original document loading tray 4 are continuously supplied one sheet at a time to an original document platform (not shown in the drawings).

The image reading unit 5 reads the image information recorded on the original document on the original document platform, and includes an optical system (not shown in the drawings).

The control unit 7 includes a micro-computer including CPU and memory, and controls the operation of input and output units such as the DF 3 and the image forming unit 11, as well as controlling image processing, described later, when stapling is specified.

The control unit 7 is capable of counting the number of pages read by the image reading unit 5, and determining the characteristics of each page as one of four types: text, photographs, graphs, and other.

Specifically, the number of character edge pixels contained in the image information that is read is counted, and if the number counted exceeds a threshold value the characteristic of that page is determined to be text. Also, the concentration distribution of the image information that is read is analyzed, and if the distribution across the high concentration and low concentration sides is a predetermined proportion the characteristic of that page is determined to be photographic. Also, if the number of character edge pixels is less than the threshold value and the concentration distribution does not have a predetermined spread, the characteristic of that page is determined to be a graph. Then, pages which do not have the characteristics of either text, photographs, or graphs are classified as “other”.

When stapling is specified, the control unit 7 determines whether the number of sheets of image information read exceeds the maximum number for stapling. If the maximum number is exceeded the control unit 7 displays an operation screen in a display unit (described later) to prompt the user to reduce the number of pages by prompting initially whether to select automatic reduction or manual reduction of the number of pages. If automatic reduction of the number of pages is selected, image processing is carried out in accordance with the image processing conditions set in advance with the operation panel 9 as default values and stored in memory. If manual reduction of the number of pages is selected an operation screen is displayed to set the image processing conditions for the reduction.

Many types of control program that are executed in the CPU are stored in the memory, as well as image information read by the image reading unit 5 and output data obtained by the control unit 7 by performing image processing to reduce the number of pages. Also, in addition to the maximum number of sheets that can be stapled, the image processing conditions set as default values by the operation panel 9 are stored in the memory.

The operation panel 9 includes a plurality of operation keys 15 and a display unit (conditions input unit, conditions setting unit) 17 comprising a touch panel type liquid crystal display.

The operation keys 15 include a start key to instruct reading the original document, printing, etc., setting keys for all types of settings, a numerical keypad, and similar.

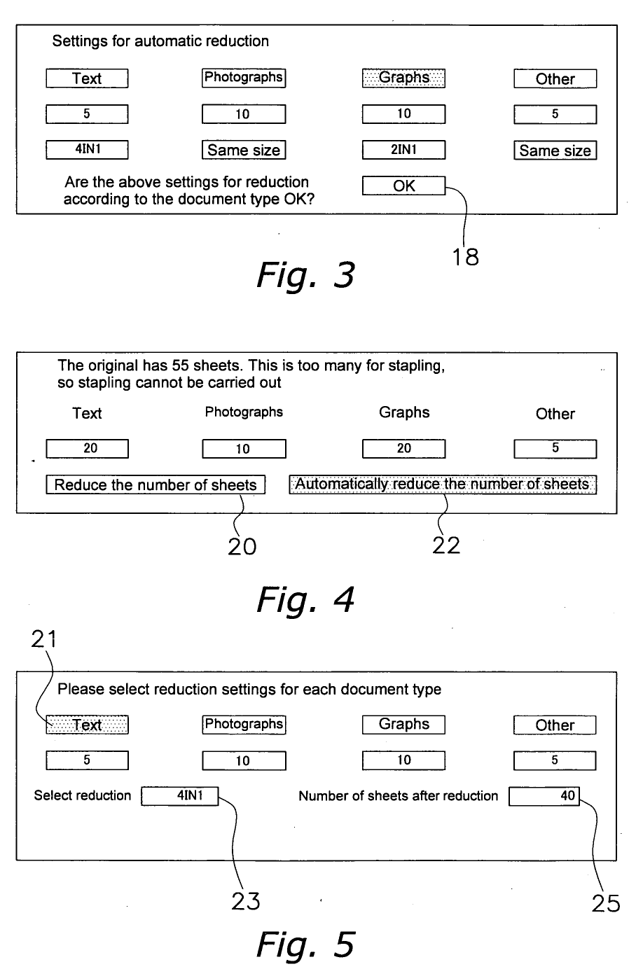

Various operation screens for setting operations are displayed in the display unit 17. One of these operation screens is an operation screen for setting the image processing conditions when carrying out automatic reduction of the number of pages, as shown in FIG. 3. The image processing conditions set using this operation screen are confirmed by pressing an OK button 18 and stored in memory.

When stapling is required and the number of sheets in the original document exceeds the maximum number for stapling, the operation screen shown in FIG. 4 is displayed in the display unit. A message indicating that stapling cannot be carried out, the total number of pages in the original document, the number of pages for each characteristic, a manual page number reduction button 20, and an automatic page number reduction button (instruction means) 22 are displayed in this operation screen.

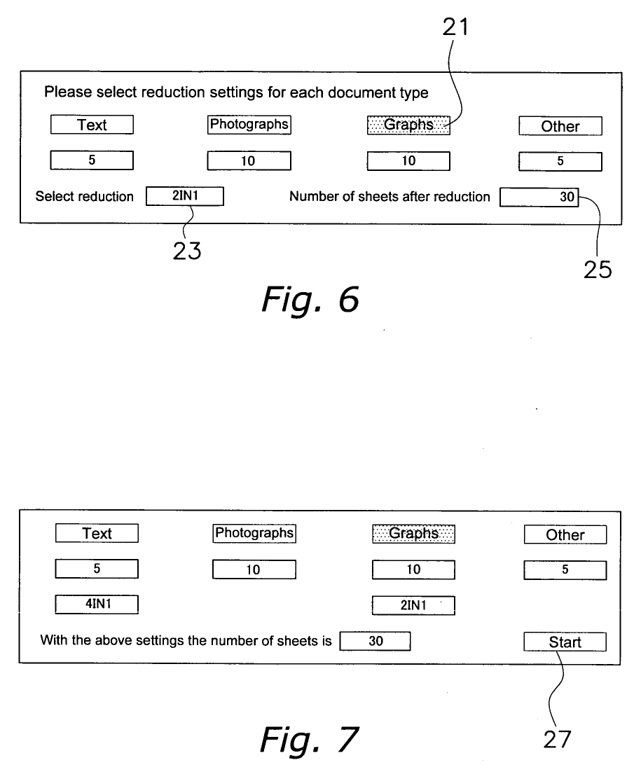

If the manual page number reduction button 20 is pressed operation screens are displayed as shown in FIG. 5 and FIG. 6. The user can press a characteristic button 21 for each page of the original document and select the desired N in 1 reduction processing or same size processing in a selection column 23. Also, a display column 25 is displayed in these operation screens, displaying the number of pages output after carrying out these N in 1 operations, so that the number of pages of output can be seen while setting the image processing conditions.

In the operation screen of FIG. 5 and FIG. 6, when the number of sheets output is equal to or less than the maximum number, a start button 27 is displayed to instruct the start of image processing in accordance with the image processing conditions, printing, and stapling, as shown in FIG. 7.

On the other hand, if the automatic page number reduction button 22 is pressed, image processing is automatically carried out in accordance with the default values stored in memory.

The image forming unit 11 outputs the output data generated by the control unit 7 onto sheets. The image forming unit 11 includes a photosensitive drum, a charging device arranged around the photosensitive drum, an exposure device, a developing device, a transfer device, and a fixing device arranged downstream of these other devices (none of these devices are shown in the drawings).

The stapling unit 13 binds a plurality of sheets with staples, and is capable of stapling up to a predetermined maximum number of sheets.

Other input and output units include a sheet supply unit, a sheet output unit, a communication unit (none of which are shown on the drawings). The sheet supply unit is for transporting sheets from a sheet supply cassette 6 or manual feed tray 8. The sheet output unit is for outputting sheets on which images have been formed to a sheet output tray 10. The communication unit is for receiving print data from an externally connected personal computer and for transmitting facsimile data between the image forming device 1 and an external facsimile device.

[Operation of the Image Forming Device]

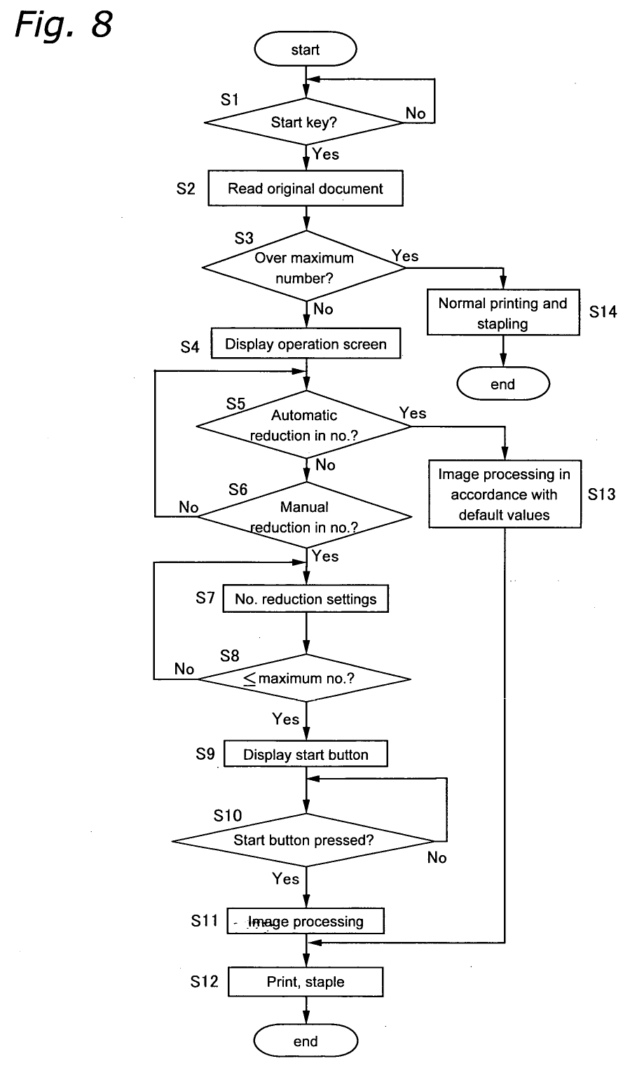

Next, an example of the operation of stapling in the image forming device 1 is explained based upon FIG. 8.

It is assumed that the maximum number of sheets for stapling in the image forming device 1 is 35 sheets. Also, it is assumed that the default values for automatic reduction of the number of pages have already been set.

To copy and staple for example an original document comprising 55 sheets in this image forming device 1, first the original document is set in the original document setting tray 4 of the DF 3, and the start key of the operation panel 9 is pressed (S1). As a result of this, the original document is fed one sheet at a time to the original document platform and the image information is read (S2). The image information that is read is stored in memory, and the number of pages is counted to determine whether the maximum number of sheets has been exceeded or not (S3).

In this example the number of sheets of the original document exceeds the maximum number of sheets, so the operation screen of FIG. 4 is displayed in the display unit 17 (S4). From this operation screen, the user can select either automatic reduction of the number of pages or manual reduction of the number of pages. If automatic reduction of the number of pages is selected (S5), automatic reduction in the number of pages is carried out in accordance with the default values already set (S13), and printing and stapling is carried out (S12).

On the other hand, if manual reduction of the number of pages is selected (S6), the operation screen shown in FIG. 5 is displayed (S7), and the user can select the desired processes for the characteristics of each page until the number of sheets output is equal to or less than the maximum number of sheets (S8). When it is determined that the number of sheets to be output is equal to or less than the maximum number of sheets, the start button 27 is displayed on the operation screen (S9). When the start button 27 is pressed (S10) image processing is carried out in accordance with the image processing conditions set in the operation screens up to this point (S11), and printing and stapling is carried out (S12).

According to the above image forming device 1, image information that exceeds the maximum number of sheets for stapling is subjected to image processing in accordance with the characteristics of the image information of each page. For example text information could be reduced by 4 in 1, photographic information left the same size, and graph information reduced by 2 in 1. Therefore the output can be easily read even when the image information has many different characteristics.

[Other Preferred Embodiments]

(a) The image forming device may be capable of one of either automatic reduction of the number of pages or manual reduction of the number of pages.

(b) In the above preferred embodiment, when the automatic page number reduction button in the operation screen of FIG. 4 is pressed, a screen the same as that in FIG. 3 is displayed once, showing the user details of the settings. In this case the settings may be further changed.

(c) In the above preferred embodiment, instead of the “other” characteristic of the original document, a mixed text and photographic characteristic may be used for pages containing both text and photographic information.

(d) When carrying out the settings for manual page number reduction, a cancel key may be displayed for exiting from the operation screen during setting operations.

(e) In automatic page number reduction, for text information the N in 1 reduction process may be selected according to the font size of the text.

(f) For each button displayed on the operation screen, hardware keys or other means may be used.

(g) The image information that is subject to page number reduction is not limited to image information read by the image reading unit. The image information may be print data transmitted from an externally connected device such as a personal computer or facsimile data transmitted from an external facsimile device.

What is claimed is:

1. An image forming device capable of stapling a plurality of sheets up to a predetermined maximum number of sheets, comprising:
an image processing unit capable of generating output data for image information for which the number of sheets would exceed the maximum number of sheets by image processing, including carrying out an N in 1 reduction (where N is a natural number equal to or greater than 2) according to the characteristics of each page of the image information;
an output unit that transfers the output data obtained from the image processing unit to a transfer medium; and
a staple unit that staples the transfer medium onto which the output data has been output.

2. The image forming device according to claim 1, further comprising a conditions input unit capable of receiving image processing conditions input for the characteristics of each page of the image information, wherein the image processing unit is capable of processing images in accordance with image processing conditions received by the conditions input unit.

3. The image forming device according to claim 2, wherein when the image processing conditions are input so that the number of sheets required by the output data is equal to or less than the maximum number of sheets, it is possible to instruct that the output data is output to the output unit.

4. The image forming device according to claim 1, further comprising:
a conditions setting unit capable of setting in advance the image processing conditions for the characteristics of the image information of each page; and
a memory unit capable of recording the image processing conditions set in the conditions setting unit, wherein the image processing unit is capable of processing images in accordance with image processing conditions recorded in the memory unit.

5. The image forming device according to claim 4, further comprising instruction means for instructing image processing in accordance with the image processing conditions recorded in the memory, wherein the image processing unit processes images in accordance with image processing conditions recorded in the memory unit when there is an instruction from instruction means.
